(19) United States
(12) Patent Application Publication
(10) Pub. No.: US 2026/0361654 A1
(43) Pub. Date: Nov. 12, 2026

(54) METHODS AND APPARATUS FOR QUALITY OF SERVICE (QOS)-FLOW-BASED SESSION MANAGEMENT IN A WIRELESS NETWORK

(71) Applicant: InterDigital Patent Holdings, Inc., Wilmington, DE (US)

(72) Inventors: Guanzhou Wang, Brossard (CA); Xavier De Foy, Kirkland (CA); Samir Ferdi, Kirkland (CA); Jung Je Son, Warrington, PA (US); Anuj Sethi, Ottawa (CA); Ulises Olvera-Hernandez, Saint-Lazare (CA); Taimoor Abbas, Sainte-Julie (CA); Michel Roy, Candiac (CA)

(73) Assignee: InterDigital Patent Holdings, Inc., Wilmington, DE (US)

(21) Appl. No.: 19/202,806

(22) Filed: May 8, 2025

(51) Int. Cl. H04L 47/24; H04L 65/1069

(52) U.S. Cl. CPC H04L 47/24; H04L 65/1069

(57) ABSTRACT

A wireless transmit/receive unit (WTRU) transmits a data connectivity request message, which requests data connectivity between the WTRU and the network, and includes a WTRU identifier (ID) and a purpose of the data connectivity. The WTRU receives information regarding a quality of service (QoS) flow for the data connectivity. The information regarding the QoS flow includes a QoS flow ID (QFID), an allocated Internet protocol (IP) address, and the purpose of the data connectivity. The WTRU receives data radio bearer configuration information for a data radio bearer, and information regarding an association between the data radio bearer and the QoS flow ID (QFID). The WTRU maps application traffic associated with the purpose of the data connectivity to the QoS flow. The WTRU marks data packets, associated with the purpose of the data connectivity, with the QFID. The WTRU sends, to a network, the data packets over the data radio bearer.

### BACKGROUND

Session Management is how the network establishes and manages data connectivity between wireless transmit/receive units (WTRUs) and the Data Networks (DNs). In the Fifth Generation (5G) System Core (5GC), the data connectivity between the WTRU and the DN is represented by a logical connection protocol data unit (PDU) Session.

Within a PDU Session, the PDUs may be sent in quality-of-service (QoS) flows, which are the finest granularity of QoS differentiation in the PDU Session. The WTRU establishes or selects the PDU Session according to the configured WTRU Route Selection Policy, and maps the PDUs to various QoS flows based on configured QoS rules. The key network function that is responsible for Session Management is a Session Management Function (SMF).

### SUMMARY

Methods and apparatus for quality-of service (QoS)-flow-based session management in a wireless network are disclosed herein. In an example, a wireless transmit/receive unit (WTRU) transmits, to a network, a data connectivity request message. Further, the data connectivity request message requests data connectivity between the WTRU and the network, and includes a WTRU identifier (ID) and a purpose of the data connectivity. The WTRU receives, from the network, information regarding a quality of service (QoS) flow for the data connectivity. Also, the information regarding the QoS flow includes a QoS flow ID (QFID), an allocated Internet protocol (IP) address, and the purpose of the data connectivity.

The WTRU receives, from the network, data radio bearer configuration information for a data radio bearer, and information regarding an association between the data radio bearer and the QoS flow ID (QFID). Further, the WTRU maps application traffic associated with the purpose of the data connectivity to the QoS flow. Also, the WTRU marks data packets, associated with the purpose of the data connectivity, with the QFID. Moreover, the WTRU sends, to the network, the data packets over the data radio bearer.

Additionally or alternatively, the purpose of the data connectivity includes an application ID. Additionally or alternatively, the purpose of the data connectivity includes a data network name (DNN).

Additionally or alternatively, the data connectivity request message further includes a radio access network (RAN) ID. Additionally or alternatively, the data connectivity request message is received by a session management entity (SME) in the network.

Additionally or alternatively, the data connectivity request message further includes a traffic type required by an application. Additionally or alternatively, the traffic type is an Internet Protocol (IP) traffic type. Additionally or alternatively, the data connectivity request message further includes connected radio access node (RAN) information.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example of a quality-of-service (QoS)-flow based user plan model;

FIG. 3 is a context diagram illustrating an example of WTRU session management context composed of QoS flow contents;

FIG. 4 is a signaling diagram illustrating an example of a high-level procedure for QoS flow-based connectivity establishment; and

FIG. 5 is a signaling diagram illustrating an example of QoS flow activation triggered by downlink (DL) data arrival.

### DETAILED DESCRIPTION

Examples and embodiments provided herein may use the following abbreviations and acronyms.
5GS 5G System
AI Artificial Intelligence
AMF Access and Mobility Management Function
AS Access Stratum
CN Core Network
DCReq Data Connectivity Request
DCReq Data Connectivity Response
DL Downlink
DN Data Network
DNAI Data Network Access Identifier
DNN Data Network Name
DNS Domain Name Service
DRB Data Radio Bearer
FQDN Fully Qualified Domain Name
EAS Edge Application Server
ECS Edge Configuration Server
EDN Edge Data Network
EES Edge Enabler Server
GTP General Packet Radio Service Tunneling Protocol
HPLMN Home PLMN
IoT Internet of Things
NAS Non-Access Stratum
NSSAI Network Slice Selection Assistance Information
NSSP Network Slice Selection Policy
RAN Radio Access Network
RF Radio Frequency
RRC Radio Resource Configuration
PCF Policy Control Function
PDU Protocol Data Unit
PDR Packet Detection Rule
PLMN Public Land Mobile Network
QFID QoS Flow ID
QoS Quality of Service
SSC Session and Service Continuity
SM Session Management
SME Session Management Entity
SMF Session Management Function
S-NSSAI Single NSSAI
TEID Tunnel Endpoint Identifier
UAV Uncrewed Aviation Vehicle
UDM Unified Data Management
UE User Equipment
UL Uplink
UPF User Plane Function
URSP UE Route Selection Policy
VPLMN Visited PLMN

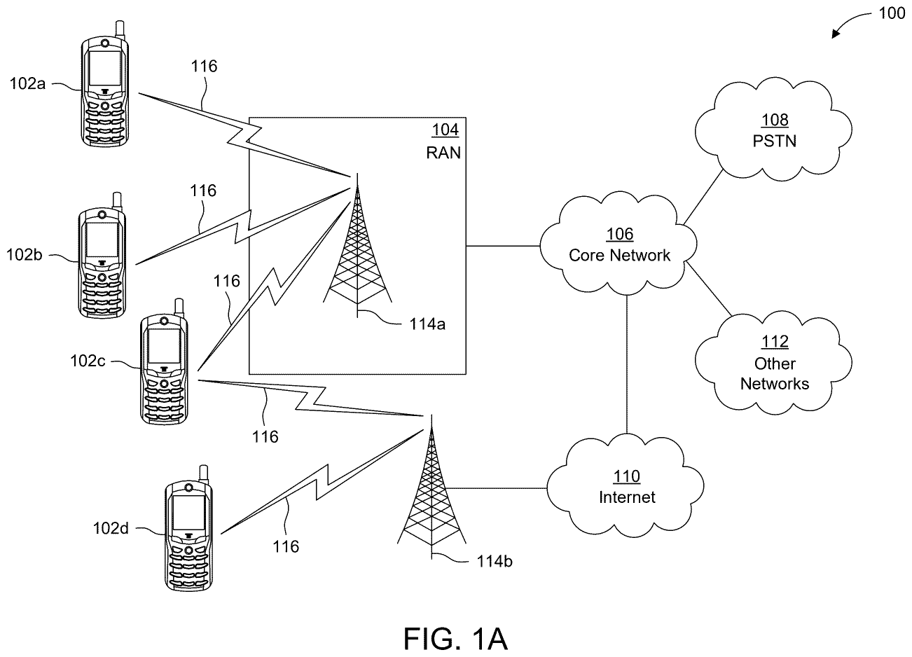

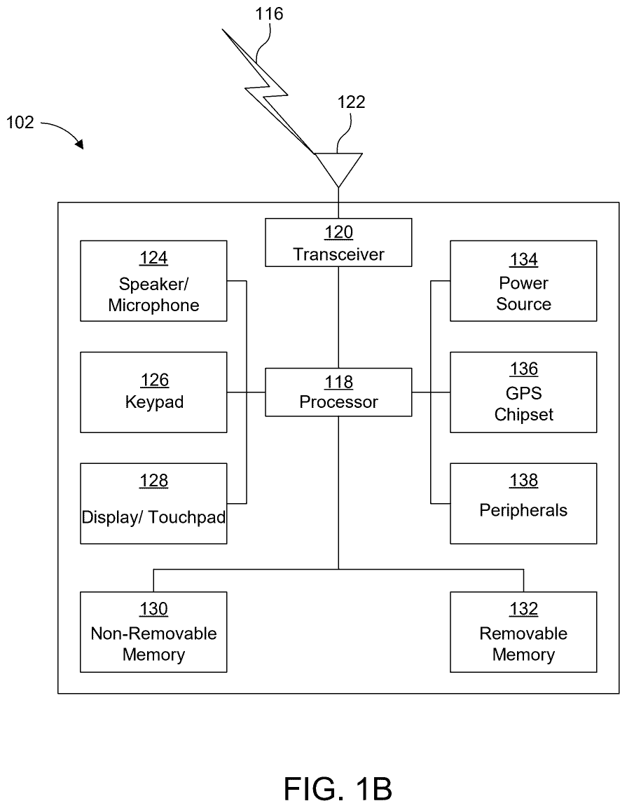

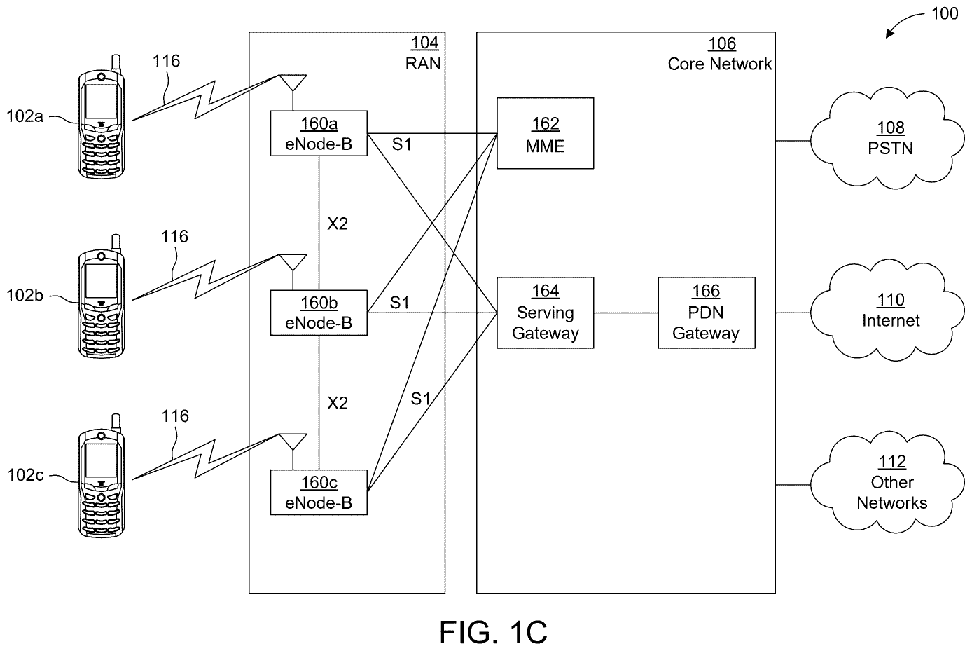

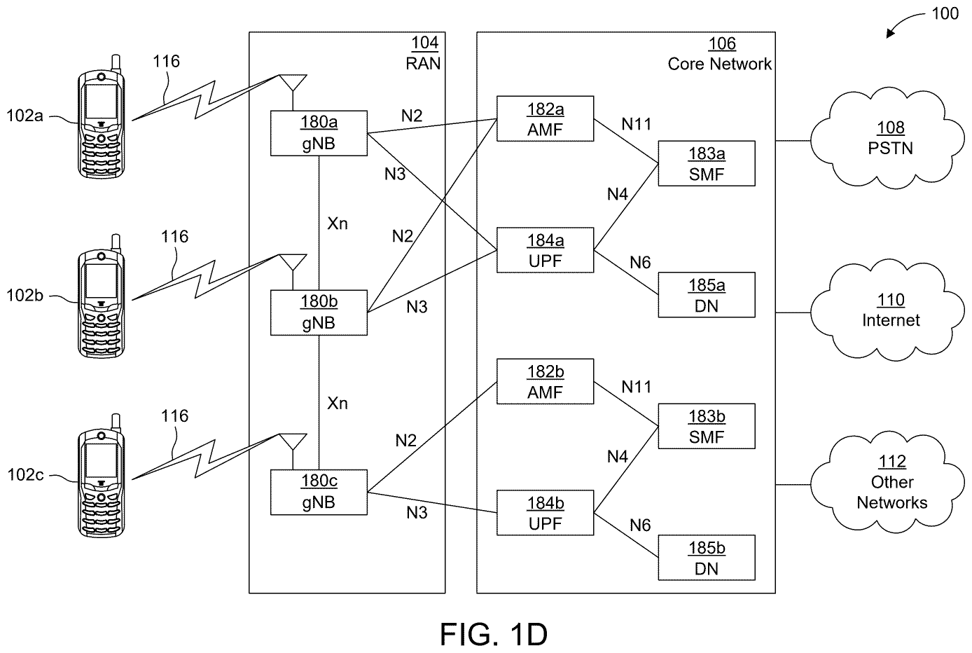

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput

### For Servicing Wtrus 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Session Management is how the network establishes and manages data connectivity between WTRUs and the DNs. In the Fifth Generation (5G) System Core (5GC), the data connectivity between the WTRU and the DN is represented by a logical connection PDU Session. Within a PDU Session, the PDUs may be sent in QoS flows, which are the finest granularity of QoS differentiation in the PDU Session. The WTRU establishes or selects the PDU Session according to the configured WTRU Route Selection Policy, and maps the PDUs to various QoS flows based on configured QoS rules.

The key network function that is responsible for Session Management is an SMF. The SMF works with other network functions such as PCF, UDM, AMF, UPF, and so forth for session management procedures. A high-level description of Session Management in 5GC can be found in Clause 5.6 of 3GGP TS 23.501. The contents of 3GGP TS 23.501 are incorporated by reference as if fully set forth herein. The detailed session management procedures, such as PDU Session Establishment, PDU Session Modification and Release, are described in Clause 4.3 of 3GPP TS 23.502. The contents of 3GGP TS 23.502 are incorporated by reference as if fully set forth herein.

In a 5G system (5GS), session management is performed in the scope of a network slice. A WTRU needs to specify the network slice identifier (NSSAI) when requesting the network to establish a PDU Session for connectivity to a Data Network. A WTRU relies on a set of rules that is configured by the network, namely Network Slice Selection Policy (NSSP) which is a part of the WTRU or UE Route Selection Policy (URSP), to derive the suitable S-NSSAI for the PDU Session and provide it to the network in the PDU Session establishment request. A WTRU also needs to be configured with a set of NSSAIs, such as the Configured NSSAI, the Allowed NSSAI, the Rejected NSSAI, and so forth (See Clause 5.15 of TS 23.501). The mechanism for a WTRU and the network to manage and use network slicing related configurations has become over-complicated in current 5G systems in large part because of the exposure of network slicing internals to the WTRU, but also due to slicing configuration mapping aspects between the VPLMN and HPLMN, the duplication of slicing information usage in the AS and NAS layers (for example, used for RAN or Core Network based AMF selection/reallocation).

In addition to NSSAI, the URSP configured in a 5G WTRU also maps application traffic to a few other parameters (in other words Route Selection Descriptors), such as PDU Session Type, DNN, SSC Mode, and so forth

Similarly, the mapping between the application traffic and the corresponding QoS flows also depends on a set of QoS rules configured (by the SMF according to PCF provisioned PCC rules) in the WTRU.

This WTRU-centric and policy-based mechanism for selecting PDU Session parameters and QoS treatments has some critical drawbacks.

First, both URSP and QoS rules depends on the known “traffic descriptors” such as IP tuples, OS AppId (Operating System Application identifier), and so forth, and only those applications that have matching “traffic descriptors” in the rule can be mapped to a set of pre-defined PDU Session parameters or QoS flow parameters. In the real world, the applications installed in the user terminal is most likely not known at the network side and thus the network is not able to include “traffic descriptors” for most user applications. These applications that do not match any specific “traffic descriptor” in the URSP or QoS rules will end up using “match-all” rules. In other words, all these application traffic will be using the same PDU Session and QoS flow parameters without differentiation.

Second, the URSP and QoS rules are mostly configured by the network based on static pre-defined information such as user subscription data, PCC rules, and so forth Though theoretically the network can update dynamically the WTRU policies, the whole mechanism is rather rigid and most of the time the rules may remain unchanged once configured in the WTRU. Especially for network slicing, a PDU Session is not allowed to change network slices once the S-NSSAI is selected at the time of the PDU Session establishment. This actually defeats the purpose of network slicing which should allow more flexible and efficient use of the network resources.

Third, the URSP is configured by the HPLMN including for VPLMN specific URSP Rules. When requesting a PDU Session in a visited PLMN, the same HPLMN-provisioned URSP rule is used and some configuration may not apply or may not be optimal in the visited PLMN. For example, the visited PLMN may implement proprietary network slices which cannot possibly be configured by the HPLMN in the URSP (as the NSSP are associated with the HPLMN, including for the VPLMN specific URSP Rules).

To add to the complexity of definition of URSP rules in the context of Network Slicing, the AF may be allowed to provide “guidance” for URSP rules determination. While this may be a useful feature, its design and applicability once again is linked to the Network Slice.

As described in 3GPP TS 23.502, “Application guidance for URSP determination is provided to the PCF in the HPLMN via the PCF of the VPLMN. The PCF in the VPLMN translates the Service Parameters values provided by the AF for inbound roamer to values applicable to the HPLMN, for example S-NSSAI.”

To address the drawbacks of the current 5G session management framework, the methods proposed by the embodiments and examples provided herein follow the following principles. First, a QoS flow, instead of PDU Session, is used as the basic logical connection between the WTRU and the Data Network. The Network and the WTRU maintain the context of QoS flows and manage the QoS flows to adapt to the performance or the network condition fluctuations.

Second, the selection and change of network slices for a certain application traffic or QoS flow is shifted from the WTRU to the network. This enables more flexible use of the network resources and relieve the WTRU from managing complicated network slicing configurations. The WTRU may be agnostic about the use of the network slice.

In the embodiments and examples below, the generic term “WTRU” is used to denote a variety of user terminal or devices such as cellphones, wearable devices, IoT devices, UAVs, sensing devices, and so forth.

In an example solution, a WTRU sends a Data Connectivity Request to the network, and the request includes the WTRU identifier and the purpose of the data connectivity which may be represented by the Application Identifier, and/or Data Network Name, or other information that may describe a target endpoint. Further, the WTRU receives from the network the information of the QoS flow for the requested data connectivity. The QoS flow information includes the QoS Flow Identifier, the allocated IP address/prefix, the associated Application Identifier and/or DNN.

Also, the WTRU receives from the network the Data Radio Bearer configuration information and its association with the QoS Flow Identifier. Moreover, the WTRU maps the application traffic to the QoS flow, marks the application data packets with the QFID and sends the data packets over the associated DRB to the network.

Examples are provided herein of QoS-flow based session management. In an example solution, a QoS flow is the basic logical connection between the WTRU and the Data Network and the session management activities include the establishment, modification and deactivation/release of one or multiple QoS flows in the WTRU. The WTRU may have multiple QoS flows, with each QoS flow bearing the connectivity to various target locations, such as a Data Network, an application or a network function, and so forth. On the network side, the WTRU's QoS flow packets are transferred between the RAN and the anchor UPF using the GTP tunnels to support WTRU mobility. One or multiple QoS flows can be associated with a GTP Tunnel.

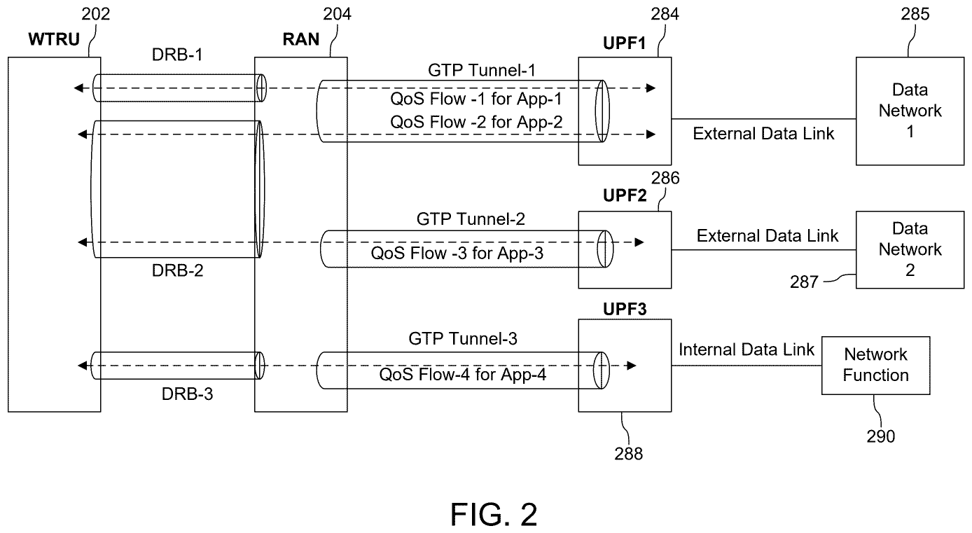

FIG. 2 is a system diagram illustrating an example of a QoS-flow based user plan model. As shown in an example in FIG. 2, the WTRU has 4 QoS flows. “QoS flow-1” is for App-1 which is hosted in external “Data Network 1” 285. “QoS flow-2” is for App-2 which is also hosted in external “Data Network 1” 285. “QoS flow-3” is for App-3 which is hosted in external “Data Network 2” 287. “QoS flow-4” is for internal data collection purposes (for example, for AIML model training, for an App-4, and so forth) and the data is sent to an internal network function 290 via an internal data link.

On the core network side, “QoS flow-1” and “QoS flow-2” are carried by the same “GTP Tunnel-1” between a RAN 204 and their common anchor UPF-1 284. “QoS flow-3” is carried by a separate “GTP Tunnel-2” between the RAN 204 and an anchor UPF-2 286. Moreover, “QoS flow-4” is carried by a separate “GTP Tunnel-3” between the RAN 204 and an anchor UPF-3 288.

On the radio interface side between a WTRU 202 and the RAN 204, “QoS flow-1” is carried by “DRB-1”. “QoS flow-2” and “QoS flow-3” are carried by the same “DRB-2”. “QoS flow-4” is carried by “DRB-3”.

Note that there is no one-to-one reciprocal mapping relationship between the QoS flows and the DRBs or the GTP Tunnels, however, one QoS flow can only be mapped to one DRB or one GTP tunnel. The RAN 204 maintains the QoS flow mapping to DRBs or GTP Tunnels separately.

In the example methods and apparatus proposed in this work, it is assumed there is a network entity SME (in other words Session Management Entity) that controls the session management for a WTRU. This network entity could be a network function such as SMF in 5GC, or it could be an AI/ML model driven module, in other words, an AI-agent, hosted by the network. Similarly, at the WTRU side, there could be an AI-agent that is responsible for session management and it works with the network-side AI-agent to complete session management related tasks. The WTRU and the SME may use legacy NAS signaling for exchanging session management related signaling, or the WTRU and the SME may establish a user plane (UP) connection (for example, a quick UDP Internet connection (QUIC)) and exchange the session management signaling via the UP connection.

Examples are provided herein of a WTRU-initiated data connectivity request. A “Data Connectivity Request” (DCReq) may be triggered at the WTRU for a variety of reasons. For example, the WTRU may need to establish an Internet connection for a launched application; or the WTRU may need to send its data as input for an AI/ML model training session performed at a network function or server; or an IoT device may need to report its sensor data to the application server, and so forth. When a DCR is triggered, the WTRU sends the DCReq message to the network. If the Session Management Entity (for example, the SME or the network-side AI-agent) address is known to the WTRU, the WTRU may directly send the message to the SME; otherwise, the WTRU may send the DCReq message to an anchor function/entity, such as the serving AMF or an AI-agent Anchor, or a RAN node, which will select the SME for the WTRU, and will forward the DCReq message to the SME. The WTRU can then be informed about the selected SME information, for example, the SME address, and the future message exchanges may be conducted directly between the WTRU and the SME. One of ordinary skill in the art can appreciate that the WTRU may first discover the SME or network side AI-Agent via the Network repository function (NRF), for example, based on the ML model id, used to assist in the data connectivity procedure, and then send the DCReq message to the discovered function, or additionally or alternatively that the WTRU may have been provisioned with a SME or network side AI-Agent or alternative node mentioned herein (for example, such as the serving AMF or an AI-agent Anchor or a RAN node) via information obtained at registration time.

In the DCReq message, the WTRU may indicate the intention or the purpose of the requested data connectivity. This intention of purpose may take different forms, depending on what triggered the DCReq. For examples, it may be represented by an “Application Identifier”, or a Connection Capability, for example, “ims”, or “internet”, that is associated with the user application (for example, Google Maps) that triggered the DCReq. Additionally or alternatively, it may be represented by a Data Network Name (for example, Internet or a VPN-identifier) that the WTRU wants to access, Additionally or alternatively, it may be “Data Collection for AIML training” if the WTRU has been triggered to send collected data to an internal network function/server for AIML model training purposes. Additionally or alternatively, it may be an IP address or FQDN of an endpoint that the WTRU wants to be connected, and so forth. The “Application Identifier” used in this document may also refer to a Service Data Flow (represented by a packet filter, for example IP tuples), or it may refer to a Multi-modal Service identifier (ID), if the QoS flow is part of a multi-modal service. The message may also indicate that the request is for communicating with a Network Function (NF) present in the core network, such as the NRF, network exposure function (NEF), and so forth, and may include an NF identifier if the WTRU has the capability of accessing the SBI bus and communicating with NF directly.

Some additional information may be provided in association with the indicated intention or purpose. For example, if the WTRU requests to send training data for AI/ML model training, the WTRU may provide a “training-session-ID” or a “training-server-ID” which can be used by the network to identify the associated training server.

The WTRU may indicate a “traffic type”, such as IP data, Ethernet packets, non-IP data, and so forth, in the DCReq. The WTRU capability information associated with the indicated traffic type may also be provided.

The WTRU may also inform the SME or the radio access network information that it is currently connected, such as the RAT type and the identifier of the RAN.

Examples are provided herein of SME actions handling the DCReq. If the DCReq is authorized by the SME, the SME may perform the following actions to establish the requested data connectivity. Note that the order of the actions in the description below doesn't correspond to the order of the execution of these actions.

First, the SME may perform WTRU SM-context retrieval or creation. The WTRU's Session Management context information (details of which is described in the examples below herein) may be stored in a SME (for example, the SME previously serving the WTRU) or a centralized WTRU Context Management Function. The current SME may query a network database (for example UDM) for where the WTRU's SM context is stored, and retrieve the SM context information from there. If the WTRU's SM context does not exist, the current SME may create the SM context and locally store it, or send it to a centralized WTRU Context Management Function.

Second, the SME may perform network slice selection. If the network supports slicing, the SME may select the network slice in which the requested connectivity will be established. The SME may make the selection based on a few factors and possibly with assistance from a PCF. For example, the selected network slice needs to support the requested Data Network or Application ID; or the SME may select a network slice that is less loaded to balance the traffic among network slices.

Third, the SME may perform DNAI selection, UPF selection, or both. The network may derive the DNAI, which identifies the location of the requested data network or application or network function, from the information in the DCReq. The network may maintain a DNAI database for all the external and internal data network or network functions that the WTRUs in the network may need to access. Also, the SME may query the database to determine the DNAI for the received DCReq. The DNAI may also be associated with one or multiple network slices (for example, a DNAI can only be assessable from a few specific network slices) so the SME may need to select the DNAI and the corresponding network slices in conjunction.

For example, if the WTRU requests a connection to the Internet, the SME may query the DNAI database (for example, using the WTRU's identifier, location and requested Application ID as the input) to receive one or multiple DNAIs that is associated with the Internet. Additionally or alternatively, the SME may further choose one DNAI if multiple DNAIs are received. For example, if the WTRU provided a Multimodal Service ID, multiple DNAIs supporting multiple data flows may be chosen.

For example, if the WTRU requests a connection to an application that is hosted in an Edge Application Server (EAS), the SME may query the DNAI database to receive the DNAI that is associated with the EAS. It can be appreciated that the WTRU may not know beforehand that a requested application or service is hosted or available in an EAS and that a connection needs to be established to an Edge Data Network (EDN). As such, the SME may firstly determine a service that may be required to fulfill the request based on the information in the DC request, then secondly determine whether the service is available as a cloud service or as an edge service, and then thirdly derive the appropriate DNAI and UPF selection based on the first and second determinations. The second determination of whether a service is available as a cloud or an edge service may require the SME to interact with one or more of a Domain Name Server(s) (DNS) and/or Edge Configuration Server(s) (ECS) and/or Edge Enabler Server(s) (EES). The ECS/EES may have the capability of providing DNAI information for edge applications.

For example, if the WTRU requests to send training data for AI/ML model training, the SME may query the DNAI database to receive the DNAI (for example using the WTRU-provided “training-session-ID” or “training-server-ID” as the input) that is associated with the training server where the model training is performed.

For example, if the WTRU (for example, an IoT device) requests to send small data over the UP to a network function, the SME may query the DNAI database to receive the DNAI (for example using the device ID or the IoT application ID as the input) that is associated with the target network function.

If the DNAI database does not have the DNAI information as requested, the DNAI database may interact with the target network function and obtain the DNAI (which may be configured in the target network function). For example, when the WTRU provides a “training-session-ID”, the “training-session-ID” may include the information of the target network function where the training session is performed. The DNAI database may interact with the target network function or with a management function (for example, edge management function) or DNS system to obtain the DNAI. For example, the DNAI database may communicate with the target network function through one or more candidate DNAIs and select a DNAI that satisfies some conditions (for example, shortest path, lowest cost, lowest round-trip time) or combination of conditions.

The DNAI database may be collocated with the NRF function in the network.

The benefit of having a universal DNAI database for all the possible target networks, endpoints or services that the WTRUs need to access is that the network operators can more flexibly and dynamically organize the relationship between the abstract network resources (for example, data network, network functions, services and applications) and the underlying physical resources (for example UPFs). For example, the DNAI database may be updated (for example, in real time) by NFs to reflect current load or congestion state of network resources associated with the DNAI. For example, a Network Slice Admission Control (NSAC) may update the DNAI database when congestion condition occurs or is cleared for one or more slices. A given DNAI associated with slices may for example not be selected by SME or provided by DNAI database to SME based on congestion status of DNAI or associated slices.

Fourth, the SME may perform QoS flow allocation and QoS profile construction. The SME may determine to create a new QoS flow and allocate a QoS Flow Identifier (QFID) for the new QoS flow. A QFID is unique within the scope of the WTRU (for example, all QoS flows in the WTRU should have different QFIDs).

If the WTRU does not indicate the desired traffic type, the SME may choose the appropriate traffic type, such as “IP” traffic, “Ethernet” traffic, or “non-IP” traffic, based on the information that the network has about the requested data network or application. The SME may allocate a WTRU address (for example, IP address), or ask the selected UPF to allocate a WTRU address, for the new QoS flow.

The SME may interact with other network functions in the network, such as Policy Control Function, to construct a suitable QoS profile (in other words a set of QoS parameters, such as those defined in Clause 5.7.1.2 and Clause 5.7.2 of 3GPP TS 23.501), for the new QoS flow.

The SME may determine to re-use an existing QoS flow for the requested data connectivity. For example, the WTRU requested new application (for example Facebook) may be in the same Data Network as a previously requested application (for example Google Maps) for which the QoS flow has already been established, in that case the SME may determine to use the same QoS flow for both applications. However, the SME may still allocate a new WTRU address for the new application even it's reusing an existing QoS flow. That is, for a QoS flow the WTRU may have different source addresses for different applications.

The QFID, together with the selected traffic type, constructed QoS profile, allocated WTRU address, selected network slice identifier, target DNN, selected DNAI and selected UPF address, GTP tunnel info, associated application identifier, and so forth may be stored in the SME as a “QoS flow context” for each QoS flow and may additionally be stored in a centralized WTRU Context Management Function. Some of the QoS Flow Context information may be sent to the WTRU, for example, in a Data Connectivity Response (DCRsp) message. The WTRU may store (for example, in QoS Flow Context cache memory) the QoS Flow Context information and use it for future QoS flow management procedures. It can be appreciated that the QoS Flow Context information provided may additionally include time and location based constraints such that, for example, cached information may expire, cached information may be used at certain periods of time or cached information may be used in certain locations.

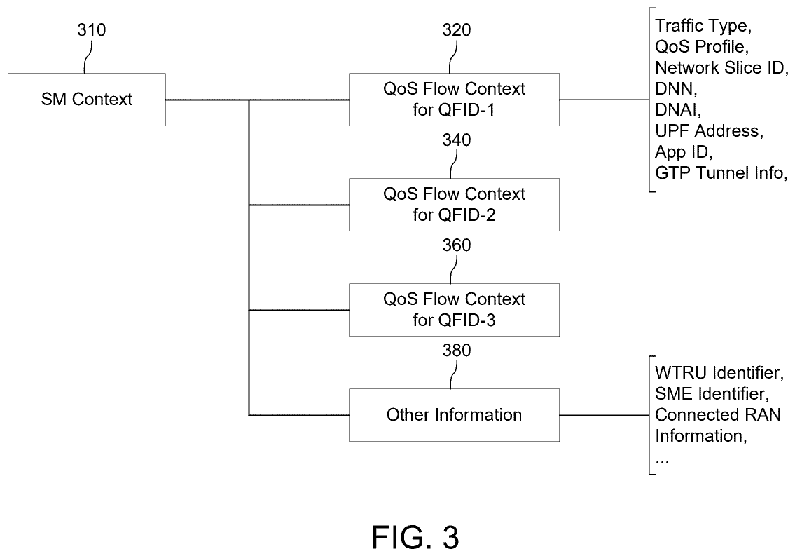

FIG. 3 is a context diagram illustrating an example of WTRU session management context composed of QoS flow contents. As shown in an example in FIG. 3, QoS flow contexts are also part of the WTRU's Session Management Context (SMC) 310. For example, QoS flow context for QFID-1 320, QoS flow context for QFID-2 340, QoS flow context for QFID-3 340, and other information 380 may be part of SM Context 310 of the WTRU. In an example, the QoS flow context for QFID-1 320 may include one or more of: a traffic type, a QoS profile, a network slide ID, a DNN, a DNAI, a UPF address, an application ID, or GTP tunnel information. Further, the other information 380 in the SM Context 310 may include one or more of: a WTRU ID, a SME ID, connected RAN information, and so forth.

Fifth, the SME may perform GTP tunnel setup. If a new QoS flow is allocated, the SME then requests the WTRU's connected RAN and the selected UPF to establish the GTP tunnel between the RAN and the UPF. Further, the SME may forward the GTP tunnel information (for example, IP address, Tunnel Endpoint ID, and so forth) between the RAN and the UPF (in other words, forward the RAN's AN Tunnel Info to the UPF and the UPF's CN Tunnel Info to the RAN). Also, the SME also stores the received GTP Tunnel Info as part of the QoS flow context.

The SME indicates the QFID and some associated QoS flow context information (for example, QoS profile) to the RAN and the UPF for the requested GTP tunnel. Therefore, a GTP Tunnel is associated with a QoS flow. The SME may determine to use an existing GTP tunnel for a new QoS flow and the SME may provide the selected existing TEIDs to the RAN and the UPF for the QoS flow. In this case, a GTP Tunnel may be associated with multiple QoS flows.

On the radio interface side, the RAN also establishes the DRB for the requested QoS flow and maintains the mapping between the QoS flow and the DRB. The RAN may choose to use an existing DRB for a requested QoS flow, for example, if it determines that the QoS treatment of the existing DRB can meet the QoS requirements of the new QoS flow. The relationship between QoS flows, DRBs and GTP Tunnels is illustrated in FIG. 2.

After a QoS flow is successfully established, the SME may send a DCRsp message to the WTRU and include one or more of the following information in the DCRsp: a QFID, a WTRU address of the QoS flow (for example IP Address), an associated App ID, Data Network or peer endpoint IP address (as received in the DCReq), or QoS Flow Context information.

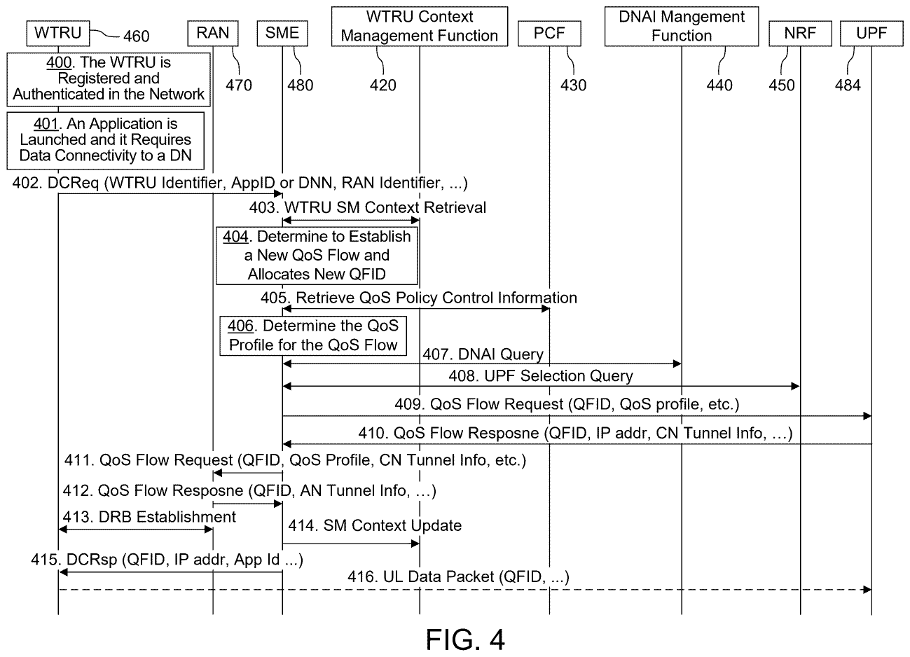

FIG. 4 is a signaling diagram illustrating an example of a high-level procedure for QoS flow-based connectivity establishment. As shown in FIG. 4, in a step 400 the WTRU 460 is registered in the network. Additionally or alternatively, the WTRU 460 is authenticated in the network.

In a step 401, an application is launched in the WTRU 460 and the application requests data connectivity to a Data Network, for example, the Internet. Additionally or alternatively, the application requires data connectivity to the Data Network.

In a step 402, the WTRU 460 sends a Data Connectivity Request message to the Session Management Entity (SME) 480 in the network. The SME 480 may be a network function such as an SMF, or an AI-agent responsible for session management, in an example. In the DCReq message the WTRU 480 may include one or more of the following information: WTRU identifier; purpose of the requested data connectivity which may be represented by the Application Identifier or the DNN or both; traffic type (for example IP) required by the application; connected RAN information; and so forth.

In a step 403, if the SME 480 does not have the WTRU's SM context information, the SME 480 may contact a centralized WTRU Context Management Function 480, which stores the WTRU context information in a centralized database, to obtain the WTRU's SM context information. The retrieved SM context information may include one or more of the following information: previously established QoS flows and the associated QoS flow contexts; previous serving SME identifier/address; or previously connected RAN information.

In a step 404, by examining the WTRU's existing QoS flow information from the SM context, the SME 480 determines that a new QoS flow needs to be established for the application and allocates a unique QFID.

In a step 405, the SME 480 interacts with the Policy Control Function (PCF) 430 in the network to retrieve the QoS control policies (QoS policy control information) from the PCF 430.

In a step 406, based on the received QoS control policies, the SME 480 determines the QoS profile for the new QoS flow to be established. The SME 480 may also select a network slice that can provide the performance required the QoS profile.

In a step 407, the SME 480 may query the DNAI Management Function 440 to obtain the DNAI information of the target DNN or where the server for the application is located.

In a step 408, based on the selected network slice and DNAI information, the SME 480 may query the Network Repository Function (NRF) 450 for the UPFs that can serve the new QoS flow.

In a step 409, the SME 480 selects a UPF 484 and sends the QoS flow request to the selected UPF 484. The SME 480 provides the QFID and associated QoS flow context and other session management context information (for example, the SME identifier) to the UPF 484. The UPF 484 may allocate the IP address/prefix and the GTP Tunnel Information (for example TEID) for the requested QoS flow and configure its QoS enforcement rules based on the received QoS profile. Other rules such as Packet Detection Rule, Forward Action Rule, and so forth can also be configured for the QoS flow (based on the instruction of the SME 480).

In a step 410, the UPF 484, returns the IP address/prefix, the CN Tunnel info, and so forth to the SME 480.

In a step 411, the SME 480 sends the QoS flow request to the WTRU's connected RAN 470. The SME 480 provides the QFID and associated QoS profile to the RAN 470. The SME 480 also forwards the received CN Tunnel Info to the RAN 470.

In a step 412, the RAN 470 allocates the AN Tunnel Info for the QoS flow and returns it to the SME 480. The SME 480 forwards the received AN Tunnel info to the UPF (not shown in the figure).

In a step 413, the RAN 470 determines to use a new DRB for the new QoS flow and initiates the DRB configuration corresponding to the QoS flow over the radio interface. The association between the DRB and the QoS flow is also informed to the WTRU 460.

In a step 414, the SME 480 updates the WTRU's SM context with the new QoS flow context and sends the updated SM context info to the WTRU Context Management Function 420.

In a step 415, the SME 480 sends a Data Connectivity Response message to the WTRU 460 and informs the WTRU 460 that a new QoS flow has been established for the requested data connectivity. The SME 480 provides the QFID, allocated IP address/prefix and associated Application ID or DNN in the DCRsp.

In a step 416, the WTRU 460 maps the application traffic to the new QoS flow, marks the UL data packets with the QFID, and sends it over the associated DRB to the RAN 470. The RAN 470 further forwards the data packets to the UPF 484 over the GTP Tunnel and keeps the QFID in the GTP packet header.

Compared to 5G PDU Session establishment procedure, the above QoS flow-based connectivity establishment procedure demonstrates at least the following benefits. One benefit is that the WTRU does not rely on complicated WTRU policy configuration to specify the details of the requested connectivity. In particular, the network slice selection is totally shifted to the network side and the WTRU is agnostic to this process. The network has more information about the network slice deployment and its status information, and thus can make more reliable and flexible choices.

Another benefit is that a middle logical connection concept “PDU Session” is removed, and a QoS flow is the basic logical connection to manage. A QoS flow is allocated by the network, and the QoS flow information and its association to the App or Data Network that triggers the data connectivity request is directly provided to the WTRU. Unlike current procedures in 5G, the WTRU relies on network-provided predefined QoS rules to map the application to a QoS flow, which may not even have an entry for the application.

A further benefit is that this User Plane model, which uses QoS flows as the basic logical connection, also enables more flexible mapping between QoS flows and DRBs or GTP tunnels.

An additional benefit is that the new model allows connection to both external data network and internal network functions, as the next generation network may have more use cases of data exchange inside the core network, such as data collection for positioning purposes or AIML model training purposes. The use of DNAI is enhanced to identify the location of the target data network or network function or endpoint.

Examples of a network initiated split of a QoS flow are provided herein. If a QoS flow carries multiple application traffic, at some point the SME may determine to split one or multiple parts of the application traffic off the current QoS flow, move them to another QoS flow or establish a new QoS flow for them. The cause for the SME to make such a decision may be that the QoS requirement for some application has changed; or the SME determines to use another anchor UPF for some application to balance the network load.

If a new QoS flow is to be established for the application traffic split off the existing QoS flow, and if the selected UPF is the same UPF of the existing QoS flow, the SME may indicate to the UPF to use the old WTRU IP address for the new QoS flow to be established. The SME will allocate a new QFID for the new QoS flow and inform the WTRU of the new QoS flow ID and the application IDs whose traffic is now to be moved to the new QoS flow. The WTRU will accordingly change its local QoS flow context for example, removing the application IDs from the context of the existing QoS flow.

If a new QoS flow is to be established for the application traffic split off the existing QoS flow, and if the selected UPF is different from the UPF of the existing QoS flow, a different WTRU IP address may be allocated by the new UPF. The SME will allocate a new QFID for the new QoS flow and inform the WTRU of the new QoS flow ID, new WTRU IP address and the application IDs whose traffic is now to be moved to the new QoS flow. The WTRU will accordingly change its local QoS flow context for example, removing the application IDs from the context of the existing QoS flow.

If some application traffic is moved from one existing QoS flow (Source QoS flow) to another existing QoS flow (target QoS flow), the SME may inform the WTRU of the new “QFID-application ID” association information for both the source QoS flow and the target QoS flow. Also, the WTRU will change its local QoS flow context for both QoS flows accordingly. If the target QoS flow has a different IP address, the application traffic moved to this QoS flow will have to change its source IP address.

Examples of WTRU-terminated data connectivity activation are provided herein. Where there is incoming traffic for a WTRU arriving at the anchor UPF, the UPF may identify the associated QoS flow for the incoming traffic, for example, based on configured PDR. If the UP connection for the QoS flow is active (for example, the TEIDs exist), then the UPF may forward the traffic over the GTP tunnel to the RAN which delivers the data to the WTRU.

In an example, a WTRU transmits, to a network, a data connectivity request message. Further, the data connectivity request message requests data connectivity between the WTRU and the network, and includes a WTRU ID and a purpose of the data connectivity. The WTRU receives, from the network, information regarding a QoS flow for the data connectivity. Also, the information regarding the QoS flow includes a QFID, an allocated IP address, and the purpose of the data connectivity.

The WTRU receives, from the network, data radio bearer configuration information for a data radio bearer, and information regarding an association between the data radio bearer and the QFID. Further, the WTRU maps application traffic associated with the purpose of the data connectivity to the QoS flow. Also, the WTRU marks data packets, associated with the purpose of the data connectivity, with the QFID. Moreover, the WTRU sends, to the network, the data packets over the data radio bearer.

Additionally or alternatively, the purpose of the data connectivity includes an application ID. Additionally or alternatively, the purpose of the data connectivity includes a DNN.

Additionally or alternatively, the data connectivity request message further includes a RAN ID. Additionally or alternatively, the data connectivity request message is received by a SME in the network.

Additionally or alternatively, the data connectivity request message further includes a traffic type required by an application. Additionally or alternatively, the traffic type is an IP traffic type. Additionally or alternatively, the data connectivity request message further includes connected RAN information.

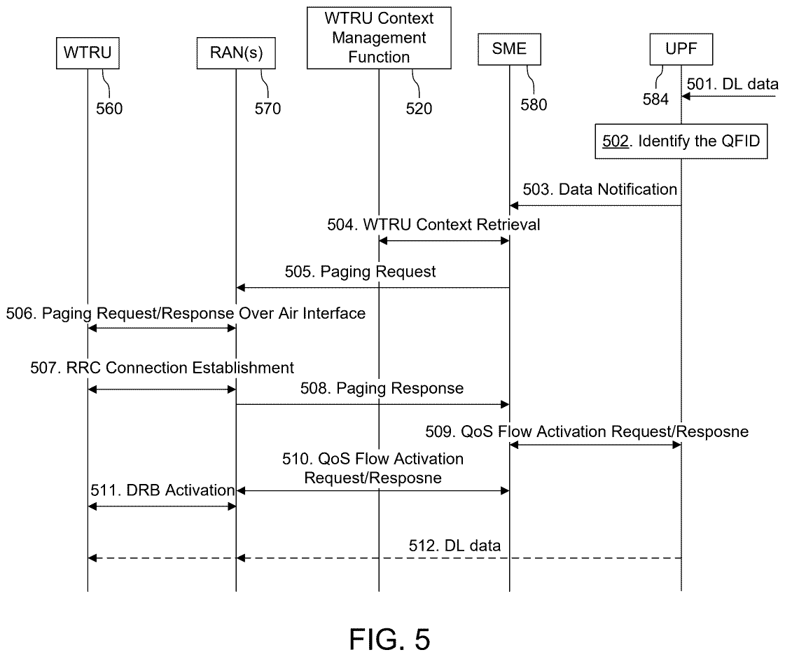

FIG. 5 is a signaling diagram illustrating an example of QoS flow activation triggered by DL data arrival. An example in FIG. 5 shows the typical procedure for activating the QoS flow and delivering the data to the WTRU if the UP connection for the QoS flow is not active.

In a step 501, DL data arrives at a UPF 584.

In a step 502, the UPF 584 identifies the QoS Flow associated with the incoming DL data, for example based on configured PDR. For example, the UPF 584 identifies the QFID. The UPF 584 checks the local QoS flow context and locates the SME address from the context.

In a step 503, the UPF 584 sends the DL Data Notification to a SME 580, and provides the WTRU identifier and the QFID of the QoS flow.

In a step 504, if the SME 580 does not have the WTRU context, the SME 580 queries a WTRU Context Management Function 520 to retrieve the WTRU context. The WTRU context may indicate whether a WTRU 560 is currently in IDLE mode or in Connected Mode. The WTRU context may also have the WTRU's latest location such as the current Tracking Area. The WTRU context may also have the WTRU's serving AMF address. If the WTRU 560 is in Connected mode, the WTRU context may also have the WTRU's connected RAN information.

If the WTRU 560 is in Connected mode, step 505 through step 508 are skipped. If the WTRU 560 is in IDLE mode, in a step 505, the SME 580 sends a Paging message to the RANs that is in the WTRU's latest location (for example Tracking Area). The SME 580 may send this Paging message directly to the RANs or via the serving AMF. The Paging message may include the WTRU identifier and the QoS flow ID that the DL data is associated with. In an example, a RAN 570 receives the paging message, which may be a paging request, from the SME 580.

In a step 506, the RAN 570 performs air interface paging procedure with the WTRU 560, and may receive the WTRU's paging response.

In a step 507, the WTRU 560 and the RAN 570 may perform the RRC connection establishment procedure.

In a step 508, the RAN 570 may inform the SME 580 (or via AMF) that the WTRU 560 has responded to the Paging and is now connected to the RAN 570. The connected RAN information is sent to the SME 580 in this Paging Response notification.

Similarly, in a step 509, the SME 580 may request the UPF 584 to activate the UP connection for the QoS flow associated with the DL data and some additional QoS flows. The UPF 584 returns the CN Tunnel Info of the activated QoS flows to the SME 580.

In a step 510, the SME 580 may request the connected RAN 570 to activate the UP connection (for example, allocate GTP TEID) for the QoS flow associated with the DL data. The SME 580 may additionally request the RAN 570 to activate other QoS flows that are in the WTRU context but not associated with the DL data. The RAN 570 returns the AN Tunnel Info of the activated QoS flows to the SME 580. The SME 580 may forward the CN Tunnel Info to the RAN 570 and the AN Tunnel Info to the UPF 584.

In a step 511, the RAN 570 performs the DRB configuration for the activated QoS flows. The RAN 570 may determine the DRB-QoS flow mapping and inform the mapping information to the WTRU 560.

In a step 512, the DL data is delivered over the established GTP tunnel to the RAN 570 which delivers it to the WTRU 560 over the air interface.

In the above procedure, the SME 580 may directly send the Paging message to the RANs which may cover the WTRU's current location, assuming the direct interface between the RAN 570 and SME 580 is available. This direct RAN-SME interface removes the need of AMF involvement, may reduce the latency of DL data delivery, and may avoid potential complicated procedures such as AMF relocation.

The QoS flow information (for example QFID) associated with the DL data may be informed to the WTRU 560 in the air interface paging message, which allows the WTRU 560 to determine the application associated with the incoming data.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
transmitting, to a network, a data connectivity request message, wherein the data connectivity request message requests data connectivity between the WTRU and the network, and includes a WTRU identifier (ID) and a purpose of the data connectivity;
receiving, from the network, information regarding a quality of service (QoS) flow for the data connectivity, wherein the information regarding the QoS flow includes a QoS flow ID (QFID), an allocated Internet protocol (IP) address, and the purpose of the data connectivity;
receiving, from the network, data radio bearer configuration information for a data radio bearer, and information regarding an association between the data radio bearer and the QoS flow ID (QFID);
mapping application traffic associated with the purpose of the data connectivity to the QoS flow;
marking data packets, associated with the purpose of the data connectivity, with the QFID; and
sending, to the network, the data packets over the data radio bearer.

2. The method of claim 1, wherein the purpose of the data connectivity includes an application ID.

3. The method of claim 1, wherein the purpose of the data connectivity includes a data network name (DNN).

4. The method of claim 1, wherein the data connectivity request message further includes a radio access network (RAN) ID.

5. The method of claim 1, wherein the data connectivity request message is received by a session management entity (SME) in the network.

6. The method of claim 1, wherein the data connectivity request message further includes a traffic type required by an application.

7. The method of claim 6, wherein the traffic type is an Internet Protocol (IP) traffic type.

8. The method of claim 1, wherein the data connectivity request message further includes connected radio access node (RAN) information.

9. A wireless transmit/receive unit (WTRU) comprising:
a processor; and
a transceiver operatively coupled to the processor; wherein:
the processor and the transceiver are configured to transmit, to a network, a data connectivity request message, wherein the data connectivity request message requests data connectivity between the WTRU and the network, and includes a WTRU identifier (ID) and a purpose of the data connectivity;
the processor and the transceiver are configured to receive, from the network, information regarding a quality of service (QoS) flow for the data connectivity, wherein the information regarding the QoS flow includes a QoS flow ID (QFID), an allocated Internet protocol (IP) address, and the purpose of the data connectivity;
the processor and the transceiver are configured to receive, from the network, data radio bearer configuration information for a data radio bearer, and information regarding an association between the data radio bearer and the QoS flow ID (QFID);
the processor is configured to map application traffic associated with the purpose of the data connectivity to the QoS flow;
the processor is configured to mark data packets, associated with the purpose of the data connectivity, with the QFID; and
the processor and the transceiver are configured to receive send, to the network, the data packets over the data radio bearer.

10. The WTRU of claim 9, wherein the purpose of the data connectivity includes an application ID.

11. The WTRU of claim 9, wherein the purpose of the data connectivity includes a data network name (DNN).

12. The WTRU of claim 9, wherein the data connectivity request message further includes a radio access network (RAN) ID.

13. The WTRU of claim 9, wherein the data connectivity request message is received by a session management entity (SME) in the network.

14. The WTRU of claim 9, wherein the data connectivity request message further includes a traffic type required by an application.

15. The WTRU of claim 14, wherein the traffic type is an Internet Protocol (IP) traffic type.

16. The WTRU of claim 9, wherein the data connectivity request message further includes connected radio access node (RAN) information.
